(19) United States
(12) Patent Application Publication
(10) Pub. No.: US 2012/0182645 A1
(43) Pub. Date: Jul. 19, 2012

(54) ROTATING MACHINE COMPRISING INSULATION SHEET FOR INSULATING COIL AND BASE, AND METHOD OF PRODUCING THE ROTATING MACHINE

(75) Inventors: Yoshio KUROKAWA, Fujieda-shi (JP); Daiki HAYASHI, Fujieda-shi (JP)

(73) Assignee: ALPHANA TECHNOLOGY CO., LTD., Fujieda-shi (JP)

(21) Appl. No.: 13/335,659

(22) Filed: Dec. 22, 2011

(30) Foreign Application Priority Data
Jan. 17, 2011 (JP) 2011-007159

(51) Int. Cl. G11B 17/02

(52) U.S. Cl. 360/99.08; G9B/17.002

(57) ABSTRACT

A rotating machine includes: a coil that is provided on the first surface side of a base and formed with a wire; an insulation sheet that has a sheet hole formed at the position aligned with the position of a guide hole in the base; and a wiring that is provided on the second surface and electrically connected to the coil. The wire forming the coil has a guide wire that is guided on the second surface side through the guide hole and the sheet hole to be connected to the wiring. The insulation sheet has an extending portion that protrudes from the sheet hole and covers at least part of the circumferential surface of the guide hole. The extending portion is placed between part of the circumferential surface of the guide hole and the guide wire.

### CROSS-REFERENCES TO RELATED APPLICATIONS

This application claims priority from Japanese Patent Application No. 2011-007159, filed Jan. 17, 2011.

### BACKGROUND OF THE INVENTION

1. Field of the Invention

The present invention relates to a rotating machine comprising an insulation sheet for insulating a coil and a base, and to a method of producing the rotating machine.

2. Description of the Related Art

In some of the rotating machines, such as hard disk drives, a rotating body is rotatably supported with respect to a base that has been fixed (see, for example, Japanese Patent Application Publication No. 2010-218612). A coil is arranged in the internal space of the rotating machine such that the rotating body is rotated by supplying a current to the coil from outside. Part of the wire forming the coil is guided outside through a guide hole formed in the base to be electrically connected to a wiring that has been arranged outside. The base is formed of a metal, such as an aluminum alloy.

Because the base is formed of a metal, a failure may occur in the rotation of the rotating body if the wire forming the coil is brought into contact with the base. Accordingly, an insulation sheet is provided between the coil and the base in order to insulate them. Thereby, a direct contact between the coil and the base can be prevented; however, there is the possibility that the wire guided from the coil may be brought into contact with the circumferential surface of the guide hole in the base. There is also the possibility that the insulation between the base and the wire may be impaired with the film of the wire being peeled off due to the rubbing between the two, the rubbing being generated by impacts and vibrations over time, even if the insulation between them has been maintained during the initial phase where they have been produced.

### SUMMARY OF THE INVENTION

The present invention has been made in view of these situations, and a purpose of the invention is to provide a rotating machine in which the possibility that a guide wire guided from a coil may be brought into contact with a guide hole in a base is reduced, and thereby the possibility that the insulation between the wire and the base may be impaired is reduced.

In order to solve the aforementioned problem, a rotating machine according to an embodiment of the present invention comprises: a base having a guide hole penetrating a first surface and a second surface opposite to the first surface; a rotating body provided on the first surface side and rotatably supported with respect to the base; an armature coil that is formed on the first surface side and formed with a wire and that is configured to rotate the rotating body; an insulation sheet that is placed between the armature coil and the base and has a sheet hole formed at the position aligned with the position of the guide hole; and a wiring that is provided on the second surface and electrically connected to the armature coil. The wire forming the armature coil has a guide wire that is guided on the second surface side through the guide hole and the sheet hole to be connected to the wiring. The insulation sheet has an extending portion that extends from the edge of the sheet hole and covers at least part of the circumferential surface of the guide hole. The extending portion is placed between part of the circumferential surface of the guide hole and the guide wire.

According to this embodiment, the possibility that the guide wire may be brought into contact with the guide hole can be reduced because the extending portion of the insulation sheet is placed between the two, and accordingly the possibility that the insulation may be impaired can be reduced.

Another embodiment of the present invention is also a rotating machine. The rotating machine comprises: a base having a guide hole penetrating a first surface and a second surface opposite to the first surface; a rotating body provided on the first surface side and rotatably supported with respect to the base; an armature coil that is formed on the first surface side and formed with a wire and that is configured to rotate the rotating body; an insulation sheet that is placed between the armature coil and the base and has a sheet hole formed at the position aligned with the position of the guide hole; and a wiring that is provided on the second surface and electrically connected to the armature coil. The wiring is adhered to the second surface of the base by an adhesive layer. A through-hole penetrating the adhesive layer and the wiring is formed in each of the two at the position aligned with the position of the guide hole. The wire has a guide wire that is guided on the second surface side of the wiring through the sheet hole, the guide hole, and the through-hole to be connected to the wiring at a position where the guide wire overlaps the internal space of the guide hole in the axial direction. The insulation sheet has an extending portion that extends from the edge of the sheet hole and covers at least part of the circumferential surface of the guide hole. The extending portion is placed between part of the circumferential surface of the guide hole and the guide wire.

According to the embodiment, the possibility that the guide wire may be brought into contact with the guide hole can be reduced because the extending portion of the insulation sheet is placed between the two, and accordingly the possibility that the insulation may be impaired can be reduced.

Another embodiment of the present invention is a method of producing a rotating machine. The method comprises: mounting an insulation sheet on a base by aligning the position of a sheet hole with the position of a guide hole; pushing an extending portion into the inside of the guide hole; and guiding a guide wire on a second surface side through the sheet hole and the guide hole.

According to the embodiment, the extending portion can be placed between the guide wire and the circumferential surface of the guide hole by pushing the extending portion into the guide hole to cover the circumferential surface of the guide hole and then by guiding the guide wire. Thereby, the possibility that the guide wire may be brought into contact with the guide hole can be reduced.

The “rotating machine” may be a device for driving a recording disk and, for example, may be a brushless motor. Alternatively, it may be a device in which a recording disk is mounted to be rotationally driven and, for example, may be a hard disk drive.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a top view illustrating a disk drive device according to an embodiment;

FIG. 2 is a sectional view, taken along the line A-A in FIG. 1;

FIG. 3 is a view explaining the insulation between a guide wire and a guide hole according to a comparative technique;

FIG. 4A is a partial sectional view illustrating both a guide hole to which an insulation sheet according to a first embodiment has been attached and the periphery thereof;

FIG. 4B is a view illustrating a variation of the insulation sheet in FIG. 4A;

FIG. 5A is a top view of the insulation sheet according to the first embodiment;

FIG. 5B is an enlarged view of the extending portion illustrated in FIG. 5A;

FIG. 6A is a top view illustrating a variation of the insulation sheet according to the first embodiment;

FIG. 6B is an enlarged view of the extending portion illustrated in FIG. 6A;

FIG. 7A is a top view illustrating a variation of the insulation sheet according to the first embodiment;

FIG. 7B is an enlarged view of the extending portion illustrated in FIG. 7A;

FIG. 8 is a view illustrating a state where the insulation sheet illustrated in FIG. 7A has been attached to a base;

FIG. 9 is a partial sectional view illustrating both a guide hole to which the insulation sheet according to the first embodiment has been attached and the periphery thereof, which illustrates a variation;

FIG. 10 is a perspective view of the base material of the insulation sheet according to the first embodiment;

FIG. 11 is an illustrative view with respect to the connection between the guide wire and a wiring according to a comparative technique;

FIG. 12A is an illustrative view with respect to the connection between a guide wire and a wiring according to a second embodiment;

FIG. 12B is a view illustrating a variation of the mode illustrated in FIG. 12A; and

FIG. 12C is a view illustrating another variation of the mode illustrated in FIG. 12A.

### DETAILED DESCRIPTION OF THE INVENTION

The invention will now be described by reference to the preferred embodiments. This does not intend to limit the scope of the present invention, but to exemplify the invention.

Hereinafter, the present invention will be described with reference to the drawings based on the preferred embodiments of the invention. The same or equivalent constituting elements and members illustrated in each drawing shall be denoted by the same reference numerals, and duplicative explanations will be omitted. Dimensions of members illustrated in each drawing are appropriately enlarged or reduced for easier understanding. Part of members not important for describing the embodiment are omitted from each drawing.

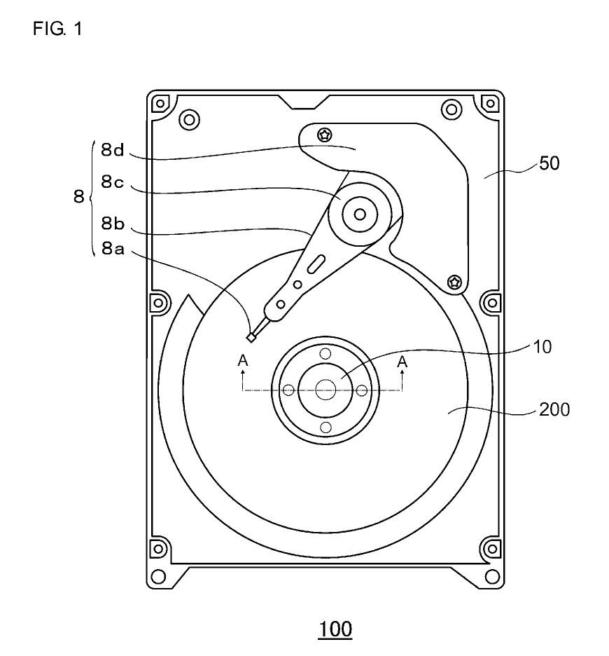

FIG. 1 is a top view illustrating a disk drive device 100 according to an embodiment. In order to illustrate the internal configuration of the disk drive device 100, FIG. 1 illustrates the state of a top cover being removed. The disk drive device 100 according to the embodiment is one example of rotating machines and functions as, for example, a hard disk drive in which a recording disk is to be mounted.

The disk drive device 100 comprises a base 50, a hub 10, a recording disk 200, a data read/write unit 8, and the top cover. Hereinafter, description will be made, assuming that the side where the hub 10 is mounted with respect to the base 50 is the upper side.

The recording disk 200 is mounted on the hub 10 to be rotated with the rotation of the hub 10. The base 50 is formed with an aluminum alloy being molded by die-casting. The base 50 rotatably supports the hub 10 via a bearing unit, which will be described later.

The data read/write unit 8 includes a recording/reproducing head 8a, a swing arm 8b, a pivot assembly 8c, and a voice coil motor 8d. The recording/reproducing head 8a is fixed to the tip of the swing arm 8b to record data on the recording disk 200 and to read data therefrom. The pivot assembly 8c supports the swing arm 8b in a swing-free manner around the head rotational axis relative to the base 50. The voice coil motor 8d makes the swing arm 8b swing around the head rotational axis such that the recording/reproducing head 8a is transferred to a desired position on the recording surface of the recording disk 200. The data read/write unit 8 is structured with a known technique for controlling the position of a head.

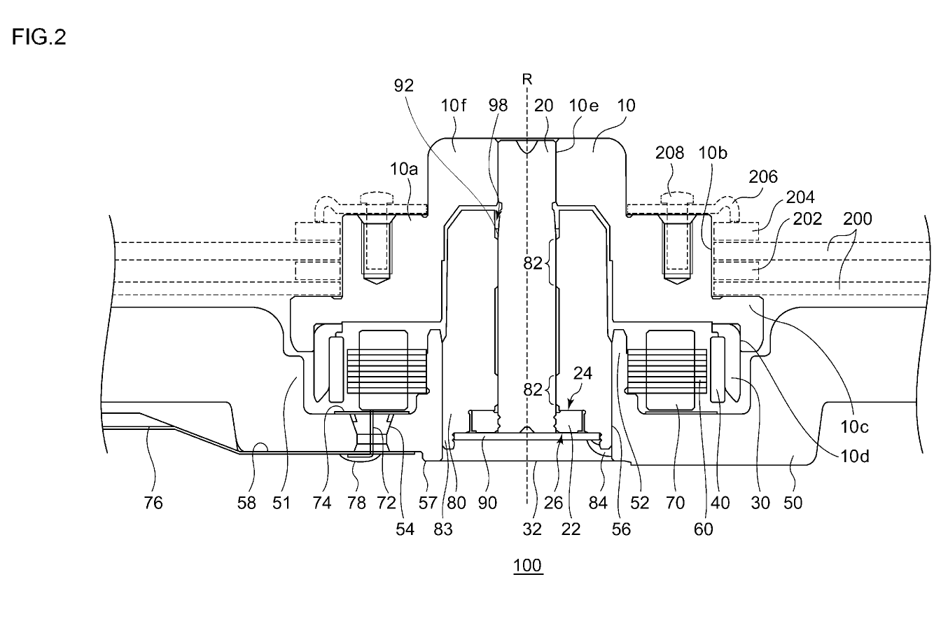

FIG. 2 is a sectional view, taken along the line A-A in FIG. 1. The disk drive device 100 rotates a plurality of, for example, 3.5″-recording disks 200 that are mounted on the device 100. In each of the supposed recording disks 200, the diameter of the hole at the center is 25 mm and the thickness is 1.27 mm. The disk drive device 100 comprises a hub 10, a shaft 20, a flange 22, a yoke 30, a sealing member 32, a magnet 40, a base 50, a stator core 60, a coil 70, a sleeve 80, a plate 90, and lubricant 92.

In the embodiment, the hub 10, shaft 20, yoke 30, and magnet 40 are integrally formed to function as a rotating body. On the other hand, the base 50, stator core 60, coil 70, and sleeve 80 are integrally formed to function as a fixed body.

The hub 10 is formed into a convex shape centered on the motor rotational axis R. A shaft hole 10e is formed at the center of the hub 10 and an annular central portion 10f is formed around the shaft hole 10e. Two annular steps are formed on the upper surface of the hub 10, and the central portion 10f is located on the highest step. A concave portion 10a concaved one step from the central portion 10f is annularly formed. A plurality of screw holes for a clamper 206 are provided at positions at circumferentially equal intervals on the upper surface of the concave portion 10a.

An annular disk fitting portion 10b is formed as a step concaved from the outer circumferential end of the concave portion 10a, and an annular extending portion 10c, which extends radially outward from the outer circumferential lower end of the disk fitting portion 10b, is formed. The annular extending portion 10c includes a hanging portion that hangs toward the base 50, and the yoke 30 is fixed to the inner circumferential surface 10d of the hanging portion.

The central holes of the two recording disks 200 are fitted into the cylindrical disk fitting portion 10b, which is a portion of the hub 10 protruding upward. Of the two recording disks 200, the lower recording disk 200 is mounted on the annular extending portion 10c of the surface of the hub 10, the annular extending portion extending radially from the lower end of the disk fitting portion 10b.

An annular first spacer 202 is inserted between the two recording disks 200. The clamper 206 fixes the two recording disks 200 and the first spacer 202 by pressing them against the hub 10 via an annular second spacer 204. The clamper 206 is fixed with respect to the concave portion 10a of the hub 10 by the plurality of clamper screws 208 after the central hole of the clamper 206 has been extrapolated into the central portion 10f of the hub 10.

The yoke 30 is fixed by adhesion to the inner circumferential surface of the hub 10. The yoke 30 has a flange portion extending radially inward from the upper end thereof and is formed into an L-shape. The upper surface of the flange portion of the yoke 30 is also fixed by adhesion to the hub 10, thereby securing an adhesive surface.

The magnet 40 is fixed by adhesion to the inner circumferential surface of the yoke 30. The magnet 40 is formed of a rare earth metal, such as neodymium, iron, and boron, and radially faces the salient pole of the stator core 60. The inner circumferential surface of the magnet 40 is provided with a twelve-pole drive magnetization in the circumferential direction thereof. That is, the magnet 40 has twelve magnetic poles at positions at circumferentially equal intervals, the positions facing those of the salient poles of the stator core 60. The yoke 30 and magnet 40 are rotated with the hub 10.

One end of the shaft 20 is firmly attached to the shaft hole 10e of the hub 10 by a combination of press fitting and adhesion. The annular flange 22 is press-fitted into the other end of the shaft 20.

An annular protruding portion 52, which protrudes upward centered on the motor rotational axis R, is provided in the base 50. The outer circumferential surface of the annular protruding portion 52 is formed into a cylindrical shape centered on the motor rotational axis R. A bearing hole 56 is formed on the inner circumferential surface of the annular protruding portion 52 and the sleeve 80 is fixed by adhesion thereto. A through-hole is formed in the sleeve 80 and the shaft 20 is housed therein. The plate 90 is fixed to the inner circumferential surface of a circumferential lower end portion 83 of the sleeve 80. A conductive resin material 84 is applied near to the joint portion between a bearing unit for the plate 90 and sleeve 80, and the base 50. An opening 57 located at the lower end of the bearing hole 56 is sealed by pasting the sealing member 32 thereto. A width-increased portion 51 is formed in the base 50 so as to axially face the hanging portion of the hub 10.

The surface of the base 50, forming the internal space, is indicated by a first surface 55, while the surface thereof, being exposed externally, is indicated by a second surface 59. The first surface 55 of the base 50 is located on the side of facing the hub 10 and the coil 70.

The lubricant 92 is injected between the shaft 20 and the flange 22 and between the sleeve 80 and the plate 90. The shaft 20, flange 22, lubricant 92, sleeve 80, and plate 90 function as a bearing unit for rotatably supporting the hub 10. That is, a rotating body including the hub 10 is provided on the first surface 55 side of the base 50 to be rotatably supported with respect to the base 50 via the bearing unit. The bearing unit is fixed to the bearing hole 56 in the base 50.

A pair of herringborn-shaped radial dynamic pressure grooves 82, which are vertically spaced apart from each other, are formed in the through-hole of the sleeve 80, i.e., on the inner circumferential surface of the through-hole. A herringborn-shaped first thrust dynamic pressure groove 24 is formed on the upper surface of the flange 22, and a herringborn-shaped second thrust dynamic pressure groove 26 is formed on the lower surface thereof. During the rotation of the disk drive device 100, the hub 10 and the shaft 20 are respectively supported in the radial direction and the axial direction by the dynamic pressures generated in the lubricant 92 with these dynamic pressure grooves.

A capillary seal portion 98, in which the gap between the inner circumferential surface of the sleeve 80 and the outer circumferential surface of the shaft 20 gradually expands toward the upper side, is formed on the open end side of the sleeve 80. The capillary seal portion 98 prevents leak of the lubricant 92 by capillarity.

The stator core 60 is fixed to the annular protruding portion 52 of the base 50 and has an annular portion and nine salient poles extending radially outward therefrom. The stator core 60 is formed by laminating multiple thin electromagnetic steel plates and by integrating them with caulking. Insulating coating is performed on the surface of the stator core 60 by electro-deposition coating or powder coating, etc. The stator core 60 is fixed by the inner circumferential surface of the annular portion being press-fitted or clearance-fitted into the outer circumference of the annular protruding portion 52.

The three-phase coil 70, an armature for rotating a rotating body, is formed by winding the wire 72 around salient poles and is provided on the first surface 55 side of the base 50. Part of the wire 72 guided from the coil 70 is referred to as a guide wire 72a.

A guide hole 54 penetrating the first surface 55 and the second surface 59 opposite to the first surface is formed in the base 50. The guide wire 72a is guided to the back surface of the base 50 through the guide hole 54 to be soldered to the wiring 76 with solder 78. The wiring 76 is provided on the second surface 59 of the base 50 and is installed into a concave portion 58 concaved from the opening 57. The wiring 76 is a flexible printed circuit board having flexibility and is electrically connected to the coil 70. An insulation sheet 74 is pasted onto the area of the base 50 facing the coil 70. Thereby, the insulation sheet 74 is placed between the coil 70 and the base 50 such that the insulation between the two is achieved.

Operations of the disk drive device 100 thus configured will be described. A three-phase drive current having an approximately sine wave shape is supplied to the disk drive device 100 in order to rotate the hub 10 in the device 100. A magnetic flux is generated along the nine salient poles when the drive current flows through the coil 70. Torque is provided to the magnet 40 with this magnetic flux, thereby allowing the hub 10 to be rotated.

### First Embodiment

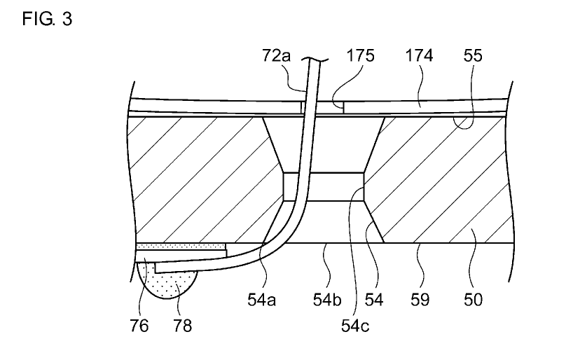

FIG. 3 is a view explaining the insulation between the guide wire 72a and the guide hole 54 according to a comparative technique. In the technique illustrated in FIG. 3, the technique being used for comparing with the first embodiment, the guide wire 72a is guided on the second surface 59 side of the base 50 through a sheet hole 175 of an insulation sheet 174 and the guide hole 54 and is connected to the wiring 76. The sheet hole 175 is formed into a circular shape by shaping the insulation sheet 174 with a mold. The guide hole 54 is formed such that the diameter thereof is progressively smaller away each of the upper and lower opening ends 54b toward the central projecting portion 54c. The central projecting portion 54c protrudes radially inward from the opening end 54b. A hole edge 54a means an area including the opening end 54b, i.e., an area around the proximity of the opening end 54b.

Because the guide wire 72a is pulled in the direction in which the wiring 76 has been provided, there are sometimes the case where the guide wire 72a is brought into contact with the hole edge 54a on the second surface 59 side, depending on the position of the wiring 76. As a result of being used over time, the guide wire 72a is often brought into contact with the hole edge 54a due to the vibrations and impacts applied to the disk drive device 100, thereby causing the fear that the insulation may not be maintained due to the peel-off of the film of the guide wire 72a.

Accordingly, in the disk drive device 100 according to the embodiment, the insulation sheet 74 is placed between the guide wire 72a and the base 50 by covering part of the guide hole 54 with the insulation sheet 74, thereby allowing the insulation between the guide wire 72a and the base 50 to be maintained.

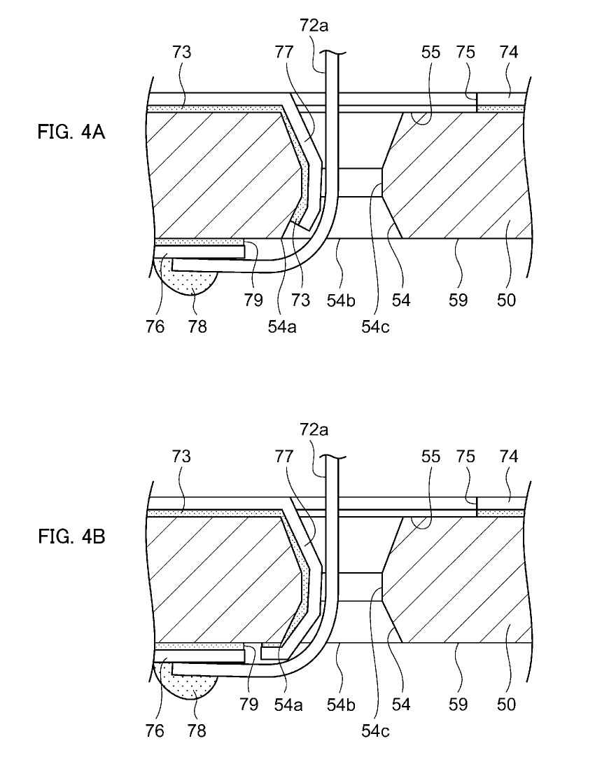

FIGS. 4A to 4B are partial sectional views illustrating both the guide hole 54 to which the insulation sheet 74 according to the first embodiment has been attached and the periphery thereof. FIG. 4A illustrates the insulation sheet 74 according to the first embodiment, while FIG. 4B illustrates a variation thereof.

As illustrated in FIG. 4A, the insulation sheet 74 is adhered to the first surface 55 of the base 50 with an adhesive member 73. The wiring 76 is adhered to the second surface 59 of the base 50 via the adhesive layer 79.

The insulation sheet 74 according to the first embodiment has an extending portion 77 that extends from the edge of the sheet hole 75 and covers at least part of the circumferential surface of the guide hole 54. The extending portion 77 is placed between part of the circumferential surface of the guide hole 54 and the wire 72a. Thereby, it can be restricted that the guide wire 72a may be brought into direct contact with the circumferential surface of the guide hole 54. The extending portion 77 is provided to cover the central projecting portion 54c that protrudes at the center. Thereby, it can be restricted that the guide wire 72a may be brought into contact with the central projecting portion 54c.

There is the problem that the guide wire 72a is likely to be drawn, of the hole edge 54a on the second surface 59 side, to the hole edge 54a in the direction of being connected to the wiring 76, thereby possibly causing the guide wire 72a to be brought into contact with the hole edge 54a. To deal with the problem, the extending portion 77 may be formed into a shape by which at least part of the hole edge 54a on the second surface 59 side of the guide hole 54 is covered, as illustrated in FIG. 4B. That is, the extending portion 77 is formed such that the length thereof in the extending direction is larger than that of the mode illustrated in FIG. 4A, i.e., larger than the length of the guide hole 54. By the insulation sheet 74 being placed between the guide wire 72a and the hole edge 54a, it can be prevented that the guide wire 72a may be brought into direct contact with the hole edge 54a, thereby allowing the insulation to be maintained even if the film of the guide wire 72a is peeled off. The insulation sheet 74 may be integrally formed with a resin film, such as PET having flexibility. The aforementioned configuration can be achieved by pasting a single sheet, and hence it is preferable in terms of easy work.

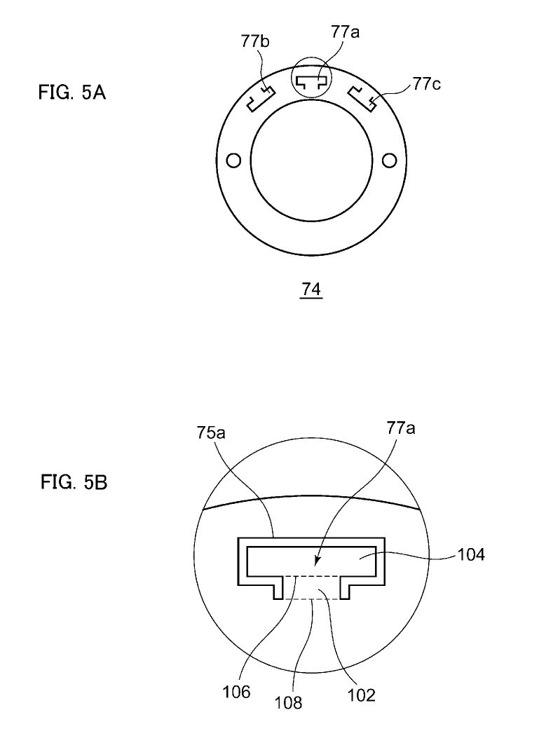

FIGS. 5A and 5B are top views of the insulation sheet 74 according to the first embodiment. FIG. 5B is an enlarged view of the extending portion 77a illustrated in FIG. 5A. This insulation sheet 74 is in a state before being adhered to the base 50. The insulation sheet 74 is formed into an annular shape such that the annular protruding portion 52 of the base 50 is inserted into the inner circumference thereof.

One guide wire 72a is provided for each phase, and three guide wires 72a, in all, are collectively guided on the second surface 59 side of the base 50 from the three sheet holes 75 and the three guide holes 54. The wire 72 for each phase has two ends of the winding-starting end and the winding-end end, and hence the three wires have six ends in all, the three winding-starting ends of which become the guide wire 72a. The three winding-end ends of the wire 72a are connected together and may not be guided. A preferred configuration is not limited to what has been described above, but a configuration in which the three winding-end ends of the wire 72 are collectively guided, a configuration in which the six ends of the wire 72 are individually guided, or a configuration in which the six ends are collectively guided is possible. In this case, a plurality of the sheet holes 75 and a plurality of the guide holes 54, the number of each of which matches the number of the guide wires 72a, are formed. The sheet hole 75 is formed in the insulation sheet 74 at the position aligned with the position of the guide hole 54 in the base 50, so that the two holes communicate with each other.

Extending portions 77a, 77b, and 77c are formed in the three sheet holes 75, respectively. The extending portion 77a extends, from the sheet hole 75, in a predetermined first extending direction, i.e., in the radially outward direction. On the other hand, each of the extending portions 77b and 77c extends in a predetermined second extending direction, i.e., in the radially inward direction. When the extending portions 77a, 77b, and 77c are not particularly distinguished from each other, they are simply referred to as an extending portion 77. In addition, the predetermined first extending direction and the predetermined second extending direction are collectively referred to as an extending direction.

The extending portion 77a has both a joint portion 102 jointed to the edge of the sheet hole 75 and a cover portion 104 provided continuously with the joint portion 102. The joint portion 102 means a portion ranging from a joint end 108 at which the joint portion 102 is jointed to the sheet hole 75 to a joint end 106 provided continuously with the cover portion 104. The cover portion 104 is formed to extend, from the joint end 106 at which the cover portion 106 is joined to the joint portion 102, in the extending direction and to protrude, from the joint portion 102, in the direction perpendicular to the extending direction. The cover portion 104 is formed into a rectangular shape, and the direction perpendicular to the extending direction becomes the longitudinal direction of the cover portion 104. When the insulation sheet 74 is adhered to the base 50, the position of the sheet hole 75 is aligned with the position of the guide hole 54 and the extending portion 77 is then pushed into the guide hole 54 while the joint portion 102 is being folded with a predetermined jig.

Herein, there is a problem that the work of pushing the extending portion 77 into the guide hole 54 requires great care. In order to deal with this problem, the joint portion 102 of the extending portion 77 is formed such that the width thereof in the direction perpendicular to the extending direction is smaller than the cover portion 104. Thereby, the joint portion 102 having a small width can be easily folded, and hence the extending portion 77 can be easily pushed into the guide hole 54, thereby allowing the workability to be improved. Further, a large area of the guide hole 54 can be covered with the cover portion 104 having a large width, and hence the possibility that the guide wire 72a may be brought into direct contact with the guide hole 54 can be reduced.

The width of the cover portion 104 in the direction perpendicular to the extending direction may be more than or equal to half the inner circumference of the guide hole 54. The inner circumference of the guide hole 54 may be the inner circumference of the central projecting portion 54c, and may be the average value of the inner circumferences of the whole guide hole 54. Thereby, the guide hole 54 is covered with the cover portion 104 across more than or equal to half the inner circumference of the guide hole 54 in a state where the insulation sheet 74 has been adhered to the base 50, and hence the possibility that the guide wire 72a may be brought into direct contact with the guide hole 54 can be reduced more surely.

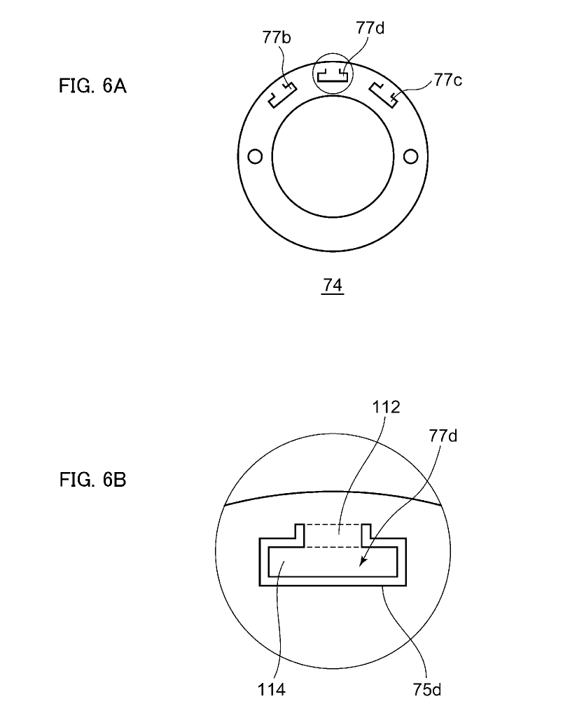

FIGS. 6A and 6B are top views illustrating a variation of the insulation sheet 74 according to the first embodiment. FIG. 6B is an enlarged view of the extending portion 77d illustrated in FIG. 6A. In this mode, the extending directions of the extending portion 77a illustrated in FIGS. 5A and 5B and the extending portion 77d are different from each other. The extending portion 77d has both a joint portion 112 joined to a sheet hole 75d and a cover portion 114 provided continuously with the joint portion 112.

Herein, in the mode illustrated in FIGS. 6A and 6B, the connection point between the wiring 76 and the guide wire 72a guided from the extending portion 77d is located radially outward from the extending portion 77d. In the connection point, the guide wire 72a is soldered to the wiring 76 with the solder 78. The guide wire 72a is likely to be drawn to the direction in which the guide wire 72a has been connected to the wiring 76, and hence the guide wire 72a can be drawn radially outward. Accordingly, the joint portion 112 of the extending portion 77d is joined to an area located radially outside the sheet hole 75d. On the other hand, in the mode illustrated in FIG. 5, the connection point between the wiring 76 and the guide wire 72a guided from the extending portion 77a is located radially inward from the extending portion 77a, and hence the joint portion 102 is joined to an area located radially inside the sheet hole 75a. That is, the position of the joint portion of the extending portion 77 is determined in accordance with the position of the connection point between the wiring 76 and the guide wire 72a guided from the extending portion 77a. Thereby, the possibility that the guide wire 72a may be brought into direct contact with the guide hole 54 can be reduced more surely.

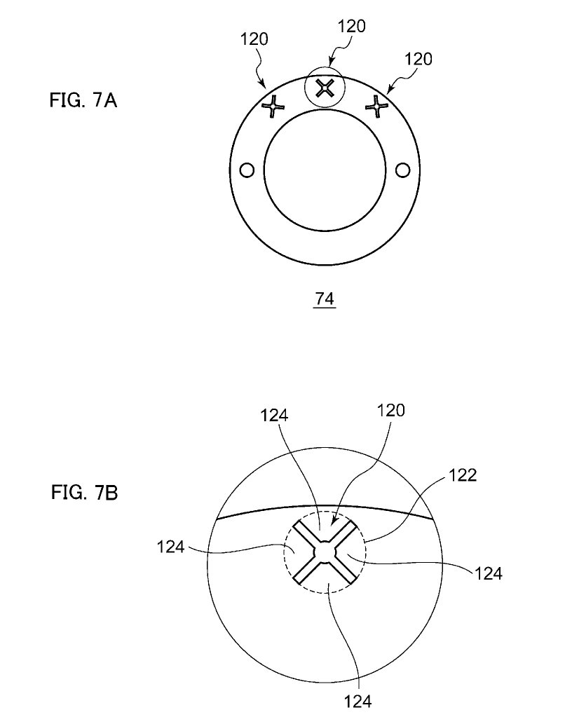

FIGS. 7A and 7B are top views illustrating a variation of the insulation sheet 74 according to the first embodiment. FIG. 7B is an enlarged view of the extending portion 120 illustrated in FIG. 7A. In this insulation sheet 74, the shape of the extending portion 120 is different from those in the modes illustrated in FIGS. 5A and 5B and FIGS. 6A and 6B.

A sheet hole 122 is formed by cutting out part of the insulation sheets 74, the part having a cross shape. The sheet hole 122 indicated by the dotted line in FIG. 7B has a shape that is formed both in a state where the insulation sheet 74 has been attached to the base 50 and in a state where protruding pieces 124 have been pushed into the guide hole 54. The shape of the sheet hole 122 indicated by the dotted line in FIG. 7B may also be changed, depending on the shape of the guide hole 54.

The extending portion 120 has a plurality of the protruding pieces 124, each of which protrudes from the sheet hole 122 and is provided in the circumferential direction of the sheet hole 122. Because the plurality of the protruding pieces 124 are arranged circumferentially, the possibility that the guide wire 72a may be brought into contact with the guide hole 54 can be reduced, irrespective of the position of the connection point between the wiring 76 and the guide wire 72a. Further, the insulation sheet can be easily attached by guiding the protruding pieces 124 from near the center of the sheet hole 122 and by pushing them into the guide hole 54.

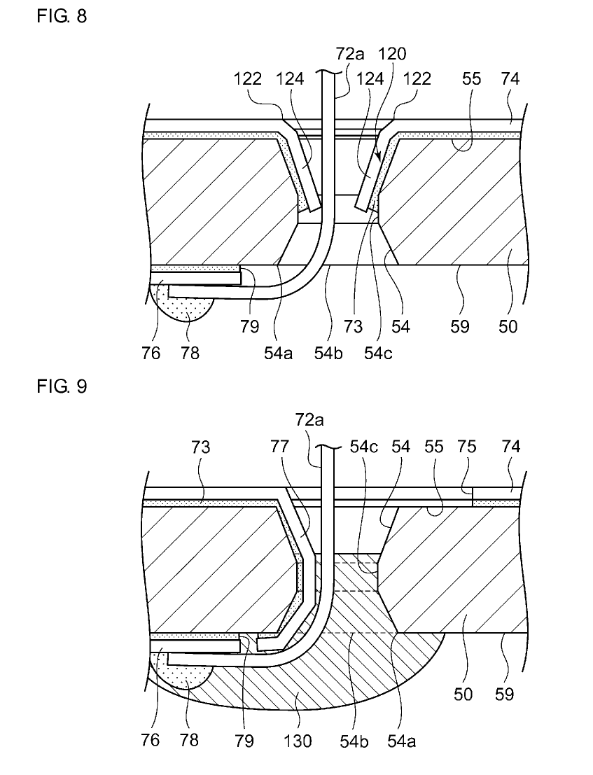

FIG. 8 is a view illustrating a state where the insulation sheet 74 illustrated in FIGS. 7A and 7B has been attached to the base 50. FIG. 8 is a partial sectional view illustrating both the guide hole 54 to which the insulation sheet 74 has been attached and the periphery thereof.

The protruding piece 124 is folded, at the edge of the sheet hole 122, toward the circumferential surface of the guide hole 54. The possibility that the guide wire 72a may be brought into contact with the circumferential surface of the guide hole 54 can be reduced by the protruding pieces 124 thus circumferentially arranged, even if the guide wire 72a is drawn to the direction of being away from the connection point due to the vibrations and impacts applied to the disk drive device 100.

Because the protruding piece 124 has the repulsive force due to its stiffness, there are sometimes the case where the protruding piece 124 comes off the guide hole 54 due to the repulsive force after being pushed into the guide hole 54. When the protruding piece 124 comes off the guide hole 54, the work of pushing it into the guide hole 54 again is needed, causing the problem that the above work requires great care. In order to deal with the problem, the adhesive member 73 may be placed between the protruding piece 124 and the circumferential surface of the guide hole 54. By adhering the protruding piece 124 to the circumferential surface of the guide hole 54 with the adhesive member 73, the possibility that the protruding piece 124 may come off the guide hole 54 can be reduced.

There is a method in which a curable resin is applied to the insulation sheet 74 and the circumferential surface of the guide hole 54 as the adhesive member 73. However, the workability is decreased in this method because it is needed to wait until the curable resin is cured. In addition, there is the fear that the curable resin prior to being cured may be attached to an unexpected area when it drips down. Accordingly, by using a double-sided tape as the adhesive member 73, the workability can be improved and it can be suppressed that the adhesive member 73 may be attached to an unnecessary area.

FIG. 9 is a partial sectional view illustrating both the guide hole 54 to which the insulation sheet 74 according to the first embodiment has been attached and the periphery thereof, which illustrates a variation. In the mode illustrated in FIG. 9, a curable resin 130 is added to the mode illustrated in FIG. 4 to fill in the guide hole 54 with the resin 130.

After the guide wire 72a and the wiring 76 have been connected to each other, the curable resin 130 is formed by being injected into the guide hole 54 and being cured. The opening end 54b on the second surface 59 side is filled in with the curable resin 130. Thereby, it can be suppressed that impure air containing foreign substances may enter a clean air space defined on the first surface 55 side via the guide hole 54. It is noted that the clean air space is an internal space mainly defined by the base 50 and the top cover and the recording space 200 is housed therein. The clean air space is sometimes referred to as an internal space of the disk drive device 100.

Alternatively, the curable resin 130 may be formed to cover the connection point between the guide wire 72a and the wiring 76. As illustrated in FIG. 9, an area including the solder 78 by which the guide wire 72a and the wiring 76 are electrically connected to each other is covered with the curable resin 130. Thereby, the connection point between the guide wire 72a and the wiring 76, which has been provided outward, can be protected by the curable resin 130, and hence disconnection in the connection point can be prevented.

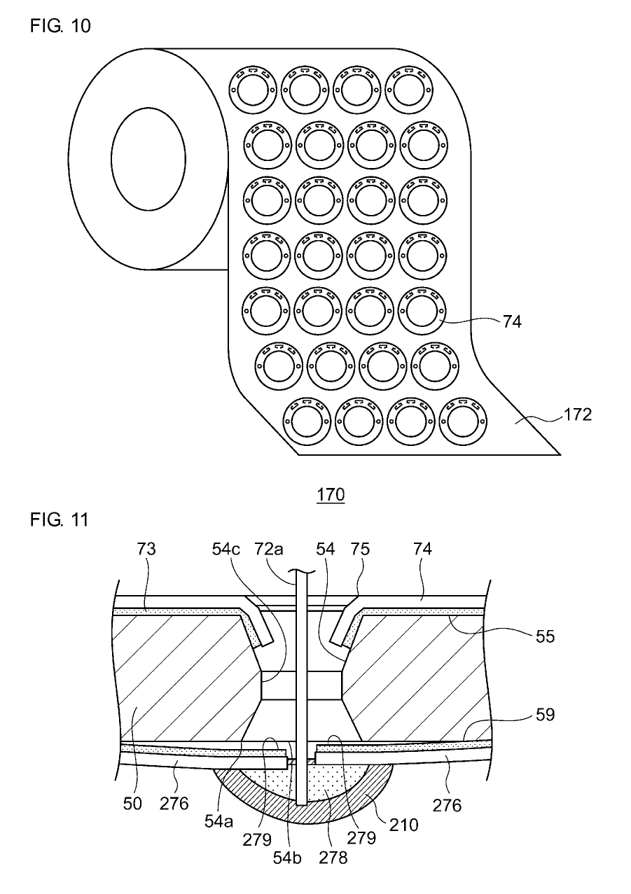

Subsequently, an example of a method of producing such the disk drive device 100 will be described. FIG. 10 is a perspective view of the base material 170 of the insulation sheet 74 according to the first embodiment.

The base material 170 of the insulation sheet 74 is configured by pasting together the sheet material 172 of the insulation sheet 74 prior to being guided, a double-sided tape, and backing paper also serving as release paper, and is formed by winding them into a roll shape. In the base material 170, the sheet material 172 and the double-sided tape are cut into a predetermined annular shape with a cutting mold in a state where they have been pasted onto the backing paper. The double-sided tape is an example of the adhesive member 73 illustrated in FIGS. 4A and 4B.

The insulation sheet 74 and the double-sided tape are released from the base material 170 to be pasted to a predetermined position on the first surface 55 of the base 50. After the pasting, the extending portion 77 is pushed into the inside of the guide hole 54 with a predetermined jig. Subsequently, the insulation sheet 74 is fixed on the first surface 55 side of the base 50 by being sandwiched with the first surface 55 and the coil 70. The guide wire 72a is then guided from the first surface 55 side to the second surface 59 side through the sheet hole 75 and the guide hole 54. Alternatively, the coil 70 may be fixed on the first surface 55 side of the base 50 simultaneously when the guide wire 72a is being guided from the first surface 55 side to the second surface 59 side. The above method is preferred in terms of shortening the working hours by simultaneously performing the fixing of the coil 70 and the guiding of the guide wire 72a. The guide wire 72a guided on the second surface 59 side of the base 50 is electrically connected to the wiring 76 firmly adhered to the second surface 59 by brazing, such as soldering, or by welding. The disk drive device 100 to which the insulation sheet 74 has been attached is produced as stated above.

### Second Embodiment

Subsequently, a disk drive device 100 according to a second embodiment will be described. FIG. 11 is an illustrative view with respect to the connection between the guide wire 72a and a wiring 276 according to a comparative technique. FIG. 11 is a partial sectional view illustrating the guide hole 54 and the periphery thereof. In the second embodiment, the connection point of the guide wire 72 is different from that in the first embodiment.

In the technique illustrated in FIG. 11, which is used for being compared with the second embodiment, the guide wire 72a is connected to the wiring 276 by solder 278 at the position to which the guide wire 72 is hanging. The solder 278 is covered with a protective film 210. Herein, if the adhesiveness between the hole edge 54a on the second surface 59 and the wiring 76 is low, a slight gap is generated between them, thereby sometimes causing foreign substances, such as dust, to enter through the gap. There has been the fear that, although the hole edge 54a on the second surface 59 has been adhered to the wiring 76 immediately after being produced, the adhesiveness may be impaired by vibrations and impacts being applied over time.

Accordingly, the disk drive device 100 according to the second embodiment is configured such that a curable resin is placed between the adhesive layer 79 and the hole edge 54a on the second surface. Thereby, the possibility that a gap may be generated between them can be reduced, even if the adhesiveness between the hole edge 54a on the second surface and the wiring 76 is low.

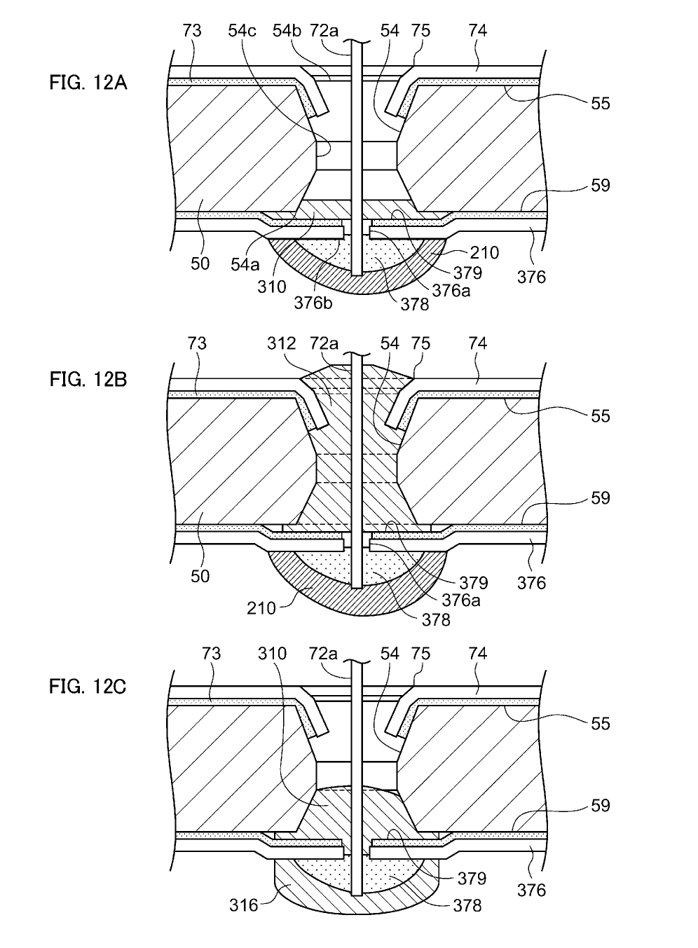

FIGS. 12A to 12C are illustrative views with respect to the connection between the guide wire 72a and the wiring 276 according to the second embodiment. FIGS. 12B and 12C respectively illustrate variations of the mode illustrated in FIG. 12A.

As illustrated in FIG. 12A, a wiring 376 is adhered to the second surface 59 of the base 50 by an adhesive layer 379. The adhesive layer 379 is a layer formed by, for example, a double-sided tape. A through-hole 376a penetrating the adhesive layer 379 and the wiring 376 is formed in each of the two at the position aligned with the position of the guide hole 54. The through-hole 376a is provided such that the diameter thereof is smaller than that of the guide hole 54 but the guide wire 72a can pass through the through-hole 376a. The guide wire 72a is guided on the second surface 59 side of the wiring 376 through the sheet hole 75, the guide hole 54, and the through-hole 376a. In addition, the sheet hole 75 may be a hole formed by cutting out part of the insulation sheet 75 and y cutting through the part, the part having a U-shape.

The guide wire 72a is electrically connected to the area surrounding the through-hole 376a of the wiring 376, i.e., to a hole edge 376b of the wiring 376 by means of soldering or welding. The through-hole 376a is filled in with solder 378b. In the second embodiment, the guide wire 72a is connected to the wiring 76 at a position where the guide wire 72a overlaps the internal space of the guide hole 54 in the axial direction. That is, the guide wire 72a is connected to the wiring 376 at a position where the wiring 376 is not fixed to the base 50. The guide hole 54 can be filled in by such a connection position of the guide wire 72a and by the configuration of the through-hole 3676a and the solder 378, without using other members. In the second embodiment, because the guide wire 72a is connected to the wiring 376 at a position where the wiring 376 is not fixed to the base 50, a gap is likely to be generated between the wiring 376 and the base 50, when vibrations and impacts are transmitted from the guide wire 72a to the wiring 376.

Accordingly, a curable resin 310 is placed between the adhesive layer 379 and the hole edge 54a on the second surface 59 in the second embodiment in order to enhance the degree of the adhesiveness of the adhesive layer 379 for adhering the wiring 376 to the base 50. By firmly curing the adhesive layer 379 and the hole edge 54a on the second surface 59 with the curable resin 310, the possibility that a gap may be generated between the adhesive layer 379 and the second surface 59 of the base 50 can be reduced. When injected between the adhesive layer 379 and the second surface 59, the curable resin 310 covers the through-hole 376a from the guide hole 54 side. Thereby, the guide hole 54 can be filled in more surely.

In the variation illustrated in FIG. 12B, the internal space of the guide hole 54 is filled with the curable resin 312, thereby allowing the internal space thereof to be filled in. By filling the internal space of the guide hole 54 with the curable resin 312 such that all of the internal space is filled up, it can be prevented more surely that impure air may enter the internal space. The curable resin 312 is formed integrally with the curable resin placed between the adhesive layer 379 and the hole edge 54a on the second surface 59. Thereby, the possibility that a gap may be generated in the curable resin can be reduced.

In addition, the curable resin 312 is formed to cover an area ranging from the internal space of the guide hole 54 to at least the inner circumference of the sheet hole 75. Thereby, the insulation sheet 74 and the curable resin 312 function as a lid of the guide hole 54, and hence it can be further prevented that impure air may enter the internal space.

In the variation illustrated in FIG. 12C, a curable resin 316 is formed to cover, on the second surface 59 side, the connection point between the wiring 376 and the guide wire 72a, in addition to the curing resin 310 formed inside the connection point. The curable resin 316 has been applied to cover the solder 378 and the wiring 376 around the solder 378 from the outer side where they do not face the base 50. Thereby, the connection point between the wiring 376 and the guide wire 72a can be protected.

The curable resin 316 covering the connection point may be formed continuously with the curable resin 310 on the inner side. That is, the curable resin 316 on the outer side and that 310 on the inner side are integrally formed by being joined together. Thereby, the whole area around the connection point can be cured by a curable resin, and hence a gap is hardly generated in these curable resins and it can be further suppressed that impure air may enter the connection point.

Subsequently, an example of a method of producing the disk drive device 100 according to the second embodiment will be described. A disk drive device generally comprises connecting members, such as connectors having a connecting terminal provided on a wiring. Each of the connectors is electrically connected to each wiring. There is a method of electrically connecting a connecting terminal to a wiring, which has been adhered to the second surface, by means of soldering or welding. However, the connector is sometimes deformed by being melted with the heat of soldering iron during the soldering. Also, there is the fear that solder and fluxes may be scattered during the soldering to be attached to the base and may enter the clean air space as foreign substances. If foreign substances enter the clean air space, operations of read/write data of a disk drive device are hampered, thereby possibly causing an error rate to be increased. In order to deal with this problem, the disk drive device 100 is produced as follows.

The connecting terminal of a connector is joined to the base material of the wiring 376 by soldering. The base material of the wiring 376 is a large sheet of flexible printed circuit board and a plurality of wirings 376 are cut out from the base material. In the wiring 376, a conductive member formed of copper foil is printed on an insulating member formed of a resin. For example, the connecting terminal is soldered to the wiring 376 by the soldering according to a reflow method. Subsequently, the wirings 76 and the connectors are separated from the base material. After being cut into a predetermined shape with a cutter or a shear tool, the wiring 376 is separated. The wiring 376 in which the connector has been arranged is then adhered to the second surface 59 of the base 50. The wiring 376 is attached to the base 50 by, for example, adhering a double-sided tape having an approximately same size as that of the wiring 376 to the wiring 376 and by adhering the double-sided tape to the base 50. It can be reduced by such a method of producing the disk drive device 100 that a connector may be deformed and solder, etc., may be scattered.

The disk drive device 100 according to the embodiment, in which the recording disks 200 each having a thickness of 1.27 mm are to be mounted, has been described; however, the disk drive device 100 is not limited thereto. For example, the thickness of a recording disk may be made to be 1.4 mm or more. Such a recording disk is preferred because a vibration in the recording disk can be suppressed by a change in the resonance frequency thereof. Alternatively, the thickness thereof may be made to be 1.7 mm or more. Thereby, a vibration in the recording disk can be further suppressed.

The disk drive device 100 according to the embodiment, in which the number of the magnet poles of the magnet 40 is twelve and the number of the salient poles is nine, has been described; however, the disk drive device 100 is not limited thereto. The number of the magnet poles of the magnet is made to be an even number of 10 to 16 and the number of the salient poles is made to be a multiple number of three of 12 to 24. Thereby, the total number of coil windings can be made large even when the magnet is miniaturized, and an increase in the cogging torque can be suppressed by making the gap between the magnet and the salient pole larger by just that much, thereby allowing a vibration occurring during the drive to be reduced.

An integrated disk drive device in which the base rotatably supports the hub has been described as the disk drive device 100 according to the embodiment; however, the disk drive device 100 is not limited thereto. For example, a motor according to the embodiment, which has been separately produced, may be attached to the chassis in the hard disk drive.

A so-called outer rotor disk drive device in which the magnet is located outside the laminated core has been described as the disk drive device 100 according to the embodiment; however, the disk drive device is not limited thereto. The technical idea according to the embodiment may be applied to the production of, for example, a so-called inner rotor disk drive device in which a magnet is located inside a laminated core.

A disk drive device in which the sleeve is fixed to the base and the shaft is rotated relative to the sleeve has been described as the disk drive device 100 according to the embodiment; however, the disk drive device is not limited thereto. The technical idea according to the embodiment may be applied to, for example, a shaft-fixed type disk drive device in which a shaft is fixed to a base, and a sleeve and a hub are rotated relative to the shaft.

In the embodiment, the disk drive device 100 mainly used in a hard disk drive has been described; however, the motor according to the embodiment may be mounted in an optical disk recording/reproducing device, such as CD (Compact Disc) device and DVD (Digital Versatile Disc) device, etc.

The present invention has been described based on the preferred embodiments, which are only intended to illustrate the principle and applications of the invention, and it is needless to say that a variety of modifications and variations in arrangement may be made to the embodiments within the range not departing from the spirit of the invention specified in appended claims.

What is claimed is:

1. A rotating machine comprising:
a base having a guide hole penetrating a first surface and a second surface opposite to the first surface;
a rotating body provided on the first surface side and rotatably supported with respect to the base;
an armature coil that is formed on the first surface side and formed with a wire and that is configured to rotate the rotating body;
an insulation sheet that is placed between the armature coil and the base and has a sheet hole formed at the position aligned with the position of the guide hole; and
a wiring that is provided on the second surface and electrically connected to the armature coil, wherein
the wire has a guide wire that is guided on the second surface side through the guide hole and the sheet hole to be connected to the wiring, and wherein
the insulation sheet has an extending portion that extends from the edge of the sheet hole and covers at least part of the circumferential surface of the guide hole, and wherein
the extending portion is placed between part of the circumferential surface of the guide hole and the guide wire.

2. The rotating machine according to claim 1, wherein
the extending portion covers at least part of the edge of the guide hole on the second surface side.

3. The rotating machine according to claim 1, wherein
the extending portion has both a joint portion joined to the edge of the sheet hole and a cover portion provided continuously with the joint portion, and wherein
the cover portion is formed to protrude, from the joint portion, in the direction perpendicular to an extending direction.

4. The rotating machine according to claim 3, wherein
the width of the cover portion in the direction perpendicular to the extending direction is determined so as to cover more than or equal to half the inner circumference of the guide hole in a state where the insulation sheet has been adhered to the base.

5. The rotating machine according to claim 1, wherein
the extending portion has a plurality of protruding pieces, each of which protrudes from the edge of the sheet hole and is provided in the circumferential direction of the sheet hole, and wherein
the protruding piece is folded, at the edge of the sheet hole, toward the circumferential surface of the guide hole.

6. The rotating machine according to claim 1, wherein
the extending portion is adhered to the circumferential surface of the guide hole.

7. The rotating machine according to claim 6, wherein
an adhesive member for adhering the extending portion to the circumferential surface of the guide hole is a double-sided tape.

8. The rotating machine according to claim 1, wherein
the guide hole has a central projecting portion protruding radially inward, the diameter of which is progressively smaller away the opening end of the guide hole, and wherein
the extending portion covers at least part of the central projecting portion.

9. The rotating machine according to claim 1, wherein
the insulation sheet is formed into an annular shape such that a protruding portion that protrudes on the first surface side of the base is inserted into the inner circumference of the annular shape.

10. The rotating machine according to claim 1, wherein
the sheet hole is formed by cutting out part of the insulation sheet, the part having a cross shape, and wherein
the extending portion has a protruding piece that protrudes from the edge of the sheet hole.

11. The rotating machine according to claim 1, wherein
the opening end of the guide hole on the second surface side is filled in with a curable resin.

12. The rotating machine according to claim 1, wherein
the connection point between the guide wire and the wiring is covered with a curable resin.

13. A rotating machine comprising:
a base having a guide hole penetrating a first surface and a second surface opposite to the first surface;
a rotating body provided on the first surface side and rotatably supported with respect to the base;
an armature coil that is formed on the first surface side and formed with a wire and that is configured to rotate the rotating body;
an insulation sheet that is placed between the armature coil and the base and has a sheet hole formed at the position aligned with the position of the guide hole; and
a wiring that is provided on the second surface and electrically connected to the armature coil, wherein
the wiring is adhered to the second surface of the base by an adhesive layer, and wherein
a through-hole penetrating the adhesive layer and the wiring is formed in each of the two at the position aligned with the position of the guide hole, and wherein
the wire has a guide wire that is guided on the second surface side of the wiring through the sheet hole, the guide hole, and the through-hole to be connected to the wiring at a position where the guide wire overlaps the internal space of the guide hole in the axial direction, and wherein
the insulation sheet has an extending portion that extends from the edge of the sheet hole and covers at least part of the circumferential surface of the guide hole, and wherein
the extending portion is placed between part of the circumferential surface of the guide hole and the guide wire.

14. The rotating machine according to claim 13, wherein
a curable resin is placed between the adhesive layer for adhering the wiring to the base and the hole edge of the guide hole on the second surface side.

15. The rotating machine according to claim 13, wherein
the internal space of the guide hole is filled with a curable resin to fill in the internal space.

16. The rotating machine according to claim 15, wherein
the curable resin is formed to cover an area ranging from the internal space of the guide hole to at least the inner circumference of the sheet hole.

17. The rotating machine according to claim 13, wherein
the connection point between the wiring and the guide wire is covered with a curable resin on the second surface side.

18. The rotating machine according to claim 13, wherein
the extending portion is adhered to the circumferential surface of the guide hole.

19. The rotating machine according to claim 18, wherein
the adhesive member for adhering the extending portion to the circumferential surface of the guide hole is a double-sided tape.

20. A method of producing the rotating machine according to claim 1, comprising:
mounting the insulation sheet on the base by aligning the position of the sheet hole with the position of the guide hole;
pushing the extending portion into the inside of the guide hole; and
guiding the guide wire on the second surface side through the sheet hole and the guide hole.
